(19) United States
(12) Patent Application Publication
(10) Pub. No.: US 2004/0172327 A1
(43) Pub. Date: Sep. 2, 2004

(54) Method for providing reductions on products and/or services

(76) Inventor: Corvin Falk, Dortmund (DE)

Correspondence Address: WILLIAM COLLARD, COLLARD & ROE, P.C., 1077 NORTHERN BOULEVARD, ROSLYN, NY, 11576, US

(21) Appl. No.: 10/484,487

(22) PCT Filed: Jul. 13, 2002
(86) PCT No.: PCT/DE02/02565

(30) Foreign Application Priority Data
Jul. 17, 2001 (DE) 101-33-975.5

(51) Int. Cl. G06F 17/60

(52) U.S. Cl. 705/14

(57) ABSTRACT

The invention relates to a method for providing reductions on products and/or services, wherein an information carrier is made available to a customer after the purchase of a product and/or in connection with the administration of services. Said information carrier contains coded information on the amount of discount offered with respect to the purchase of a product or administration of a service. The information of the information carrier is inputted into a telecommunication device and transmitted to a central management unit by means of said telecommunication device via a telecommunication network. In the management unit, free telecommunication services or other data services corresponding to the value of the discount on the product or the service are automatically credited to the customer and can be used immediately or at a later stage by the customer by means of telecommunication devices with the aid of technical devices provided by the central management unit, whereupon the discount thus provided expires.

### SPECIFICATION

The invention relates to a method for granting rebates on products and/or services, in accordance with the preamble of claim 1.

Granting rebates on products that have been purchased and/or on services that have been performed is a practice that has been usual for a long time, with which a dealer intends to bring about an additional purchase incentive for customers.

At the beginning of the 20^{th} century, in particular, rebate systems were used in which a number of rebate stamps that corresponded to the purchase amount was issued to the customer with every purchase; the customer collected these stamps and after pasting them into a collection book and having reached a specific number of rebate stamps, was able to return them to the dealer and to exchange them for a corresponding financial participation or benefit. Such rebate systems involved a great amount of effort for the customer, and also the advantage of the rebate systems only resulted when a specific number of collected rebate stamps was reached, therefore it was not directly connected with the purchase being made, in each instance, or with the use of a service.

Particularly when noting the elimination of the rebate law in Germany, rebates on products and/or services will increasingly prove to be an important purchase argument of commerce, whereby a customer tie between the dealer and the customer, as in conventional rebate systems, will be found to a lesser and lesser degree. Therefore there is the need to introduce a system with which the customer can have a rebate paid out to him/her, even for small purchases from many different dealers, without making it necessary to pay out money as the rebate, which reduces the purchase incentive.

It is therefore the task of the present invention to propose a method for granting rebates on products and/or services, in which the customer can claim a rebate immediately or in a direct time connection with the purchase of a product or the performance of a service, whereby the technical handling is supposed to take place in extensively automated manner and therefore cost-effectively, for the customer and for the dealer or vendor of a product or a service.

The solution of the task according to the invention is evident from the characterizing features of claim 1, in interaction with the characteristics of the preamble. Further advantageous embodiments of the invention are evident from the dependent claims.

The invention proceeds from a method for granting rebates on products and/or services, which is being developed further in that an information carrier is made accessible to a customer at the purchase of a product and/or in connection with receiving services, which carrier contains information about the amount of a rebate issued to him/her for the purchase of the product or for receiving the service, in coded form, and/or about the product or the service, that the information of the information carrier is fed into a telecommunication device by the customer, and transmitted to a central administration unit by way of a telecommunication network, by means of the telecommunication device, and that the customer automatically receives credit for the value of the rebate on the product or the service, in the administration unit, for telecommunication services or other data technology services, free of charge to the customer, which the customer can make use of immediately and/or with a time delay, by means of telecommunication devices, by way of technical facilities made available by the central administration unit, whereupon the rebate that was granted expires. Using the aids of modern communication technology, particularly cell phones or the like, for example, it is therefore possible to establish a rebate system that is particularly simple and cost-effective and can be used by practically anyone, since cell phones have become so widespread, in the meantime, which system allows granting rebates in a direct connection with the communication devices used. At the same time, the vendor of the service or the product, and also the manufacturer of the product, are given the opportunity to establish a contact with the customer that goes beyond the typical selling paths, since the customer can transmit an ID that identifies him/her, along with the information of the information carrier, in a further development, and thereby a direct connection can be made between the purchase of a product or the use of a service, and the customer in question. At the same time, the handling of the rebate system is extensively automated for the dealer or the vendor of the product or the service and, at the same time, for the customer, and therefore can be handled quickly and cost-effectively. The rebate can be granted in the form of free telecommunication services or also other data technology services, which the customer can take advantage of using the same telecommunication device that he/she used for transmitting the information of the information carrier. Therefore the rebates can actually be utilized by the customer directly in the store, so that the rebate system allows a particularly fast link between the purchase and the use of the rebate, and thereby exercises a particularly lasting impression on the customer. The use of telecommunication services or other similar technological services essentially serves as the currency in which the rebate is paid out.

In a first advantageous embodiment, it is provided that an ID, preferably the phone number of the telecommunication device, is sent to the central administration unit together with the information about the rebate and/or the product or the service, with which the customer can be clearly identified. Therefore it is possible for the dealer and the vendor of the service or the product to clearly produce a link between the sale of the product or the use of the service and the customer, which can form the basis for further contacts with the customer.

It is particularly advantageous if the amount of the rebate transmitted by means of the telecommunication device is automatically credited to the customer in a customer-specific account, using the customer-specific ID, preferably in a database, and stored there until the telecommunication service or other data technology service is utilized. In this way, the customer can take advantage of larger and therefore more expensive telecommunication services or other data technology services, also when making many small purchases, which result in only small rebate amounts, by collecting such small rebate amounts.

For an assessment of the purchases made or the services used, it is advantageous if the information about the product purchased or the service utilized that was sent to the central administration unit is stored by the central administration unit together with the data of the customer. For example, in a further development, a user profile can be created from the information of every customer that is sent to the central administration unit, which reflects the consumer behavior of the customer. In this connection, it is also possible that the information about the product purchased or the service utilized and the data of the customer or the customer-specific user profile are transmitted to the vendor of the product or the performer of the service. This can be transmitted in anonymous manner, for example, and it is also possible that the data are transmitted to the vendor of the product or the performer of the services linked with the user profile, if the customer agrees. In this way, a significantly stronger bond, on the whole, can be produced between the vendor of the product or the performer of the service, and the customer, which the vendor of the product or the performer of the service can transmit by way of the telecommunication device, for targeted information to the customer, for example. Therefore the customer can be informed about special offers or other, new products of the vendor of the product or service, in targeted manner. This results in a particularly strong customer bond.

It is advantageous if cell phones and/or land-line telephones are used as the telecommunication devices. Because of the widespread distribution of cell phones and, of course, of land-line telephones, practically any customer can take advantage of the rebate issued to him/her, close to the time of purchase or actually in the store, and can contact the central administration unit to register the rebate, without any significant costs.

In this connection, it is advantageous if the information is transmitted by the customer to the central administration unit by means of SMS messages, by means of voice transmission by way of a land-line telephone, preferably a telephone that is capable of tone dialing, or by means of input by way of an Internet interface.

It is possible, in this connection, as a form of the rebate, that any type of data transmission, particularly e-mail messages, fax transmissions, SMS messages, transmission of video sequences, individual pictures, audio sequences, documents, or any form of data transmissions billed in time-dependent or volume-dependent manner can be utilized by the customer as the telecommunication service. Since the telecommunication devices are of essential significance for claiming the rebate, within the method of granting a rebate, it can also be assumed that the customer makes extensive use of these telecommunication devices and therefore a rebate in the form of telecommunication services he/she can utilize at no expense for him/her contains a great incentive for use of the rebate system.

Also, it is possible, particularly in connection with the use of telecommunication services as other data technology services by the customer, that making available memory space on a storage unit made available by the central administration unit is also advantageous. For example, vacation pictures, which require a corresponding memory volume and where it is an advantage for the customer to be able to make use of external memory volume, can be sent to third parties in this manner.

Furthermore, it is possible that information concerning the rebates of several products purchased and/or services used is transmitted to the central administration unit at the same time, in a message from the customer. In this way, the costs for the transmission of rebates granted, from the customer to the central administration system, can be clearly reduced for the operator of the method.

Likewise, it is possible that the customer opens up an account with the central administration unit, particularly by providing personal data, before the first time he/she takes advantage of a rebate. In this way, not only the ID of the telecommunication device of the customer, but also other important data, are available to the operator of the method, and with the customer's permission the operator can pass this information on to the vendor of the product or services. Within the scope of opening up such an account, for example, the account can be filled up by the customer by paying in rebate amounts in the form of monetary amounts paid in, in order to be able to use telecommunication services even before the first purchase of a product or the use of a service with a corresponding rebate.

The method undergoes another simplification if the customer sets his/her telecommunication device in such a manner that he/she handles his/her communications entirely by way of communication devices of the central administration unit or, optionally, when calling up the rebated telecommunication services or the other data technology services. This can be done, for example when using SMS messages, in that the short-message central number (SMSC) set at the telecommunication device refers to the central administration unit. In this way, the customer does not have to input the number of the central administration unit again every time, but instead can handle all of his/her SMS message traffic by way of the administration unit, for example.

Another embodiment provides that the customer calls up a rebated telecommunication service or another data technology service from the central administration unit anonymously, in that he/she transmits only the coded information about the amount of the discount granted to the central administration unit, in direct connection with or directly integrated into a message transmission, and that the central administration unit passes this message on to the recipient specified by the customer, immediately after having checked the coded information. In this way, the anonymity of the customer with regard to the central administration unit is guaranteed, and at the same time, it is possible to reliably check in the central administration unit whether the message to be transmitted, or the like, can actually be paid for by means of a corresponding rebate, for example in that the information of the information carrier is contained in the message itself, or is transmitted in direct connection with it. In this case, the rebate is not credited to an account of the customer, therefore the customer remains anonymous with regard to the administration unit and therefore also with regard to the vendor of the product or service.

It is of particular advantage with regard to handling if the coded information of the product or in connection with the service is automatically detected by the telecommunication device. This can be done, for example, in that the coded information is read by a scanner integrated into the telecommunication device, or the like. In this way, the customer is spared any complicated and error-producing procedures of typing in number codes or the like, so that the transmission of the information of the information carrier is made more reliable and, at the same time, simplified for the customer. It is advantageous if such a scanner is integrated into the telecommunication device and can therefore be carried along by the customer without any additional effort.

Likewise, it is possible that the coded information is arranged on the product in the form of a transponder, and is read out by a detection unit that is integrated into the telecommunication device. Corresponding transponder/detection systems are fundamentally known, for example in the sector of securing goods against theft, and will therefore not be explained in greater detail here.

It is particularly advantageous if a number code arranged on the product in covered manner is used as the coded information, which can only be exposed after purchase of the goods. This guarantees that the number code of products that have not yet been purchased can be read in the store and claimed for rebates, for example by means of cell phones.

Furthermore, it is possible that the bar code, particularly the EAN code, can be used as part of the coded information; this code is usually affixed to products for automatic scanning of the price. Since such a code is generally affixed to the products in any case, a corresponding application of the information could already take place at the manufacturer, by means of an addition to this code, and costs could thereby be saved.

Furthermore, it is possible that when an attempt is made to utilize telecommunication services or other data technology services that are not covered by the customer's account balance, the data transmission is not transmitted to the addressee indicated by the customer and instead, a message to this effect is sent to the customer. This prevents the customer from assuming that a message has reached its recipient, if a message was mistakenly sent without being covered by a rebate, but at the same time, this message was not passed on at all.

A particularly preferred embodiment of the method according to the invention is shown in the drawing.

This shows:

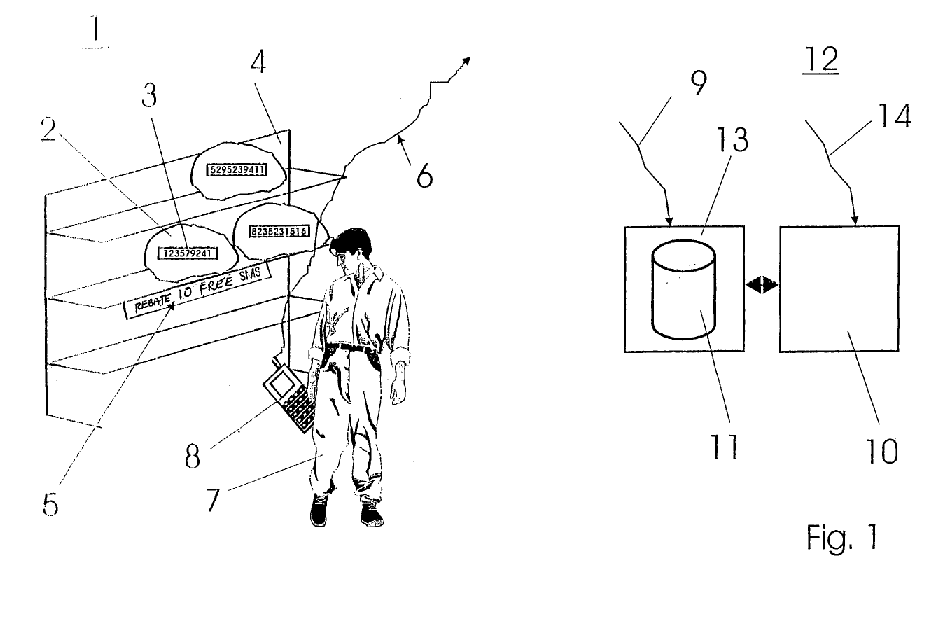

FIG. 1—a greatly simplified schematic representation relating to the interaction of technical devices in the implementation of the method according to the invention.

FIG. 1 shows the fundamental sequence of a method according to the invention, using typical devices, in a very greatly simplified and schematic manner.

Here, a customer 7 can be seen, for example in connection with the purchase of a product 2, in a store 1, who reports a rebate 5 posted on a shelf 4 to a central administration unit 12, by way of SMS messages 16, by means of a mobile communication device 8, for example a cell phone. In this connection, the customer 7 can input information 3, which is affixed to the product 2 in coded form, symbolized simply by a number sequence here, into the cell phone 8, and transmit it to the administration computer 13 of the central administration unit 12, in wireless manner, by way of an SMS message 6. The coded information includes information about the value of the rebate granted, if necessary also about the product sold, or other product-specific information that identifies the manufacturer of the product 2, and which is of interest otherwise, if necessary. At the same time, the cell phone number of the customer 7 is transmitted along with the wireless transmission 6, for example, in order to clearly identify the customer 7 with regard to the administration computer 13.

Once such a message 9 has been received by the administration computer 13, the rebate is credited to an account belonging to the customer 7, in a database 11, and entitles the customer to receive telecommunication services, for example, of a switching unit 10, which is only indicated schematically, to which the customer can turn by way of his/her cell phone 8, by means of a wireless transmission 14, and send an SMS, for example. When taking advantage of such a telecommunication service, the rebate of the customer 7 is reduced or set to zero in the database 11, depending on the extent to which the telecommunication service was utilized.

FIG. 1 does not show this, but it is fundamentally also possible that the information 3 on the product 2 is automatically identified by the cell phone 8, and is transmitted to the administration computer 13, combined with the cell phone number of the customer 7.

### REFERENCE NUMBER LIST

1—store

2—product

3—information

4—shelf

5—rebate advertisement information

6—outgoing transmission

7—purchaser

8—mobile communication device

9—incoming transmission with rebate registration

10—switching unit

11—database with rebate registration

12—central administration unit

13—administration computer

14—incoming transmission for telecommunication service

1. Method for granting rebates on products and/or services,
characterized in that
an information carrier is made accessible to a customer at the purchase of a product and/or in connection with receiving services, which carrier contains information about the amount of a rebate issued to him/her for the purchase of the product or for receiving the service, in coded form, and/or about the product or the service,
that the information of the information carrier is fed into a telecommunication device and transmitted to a central administration unit by way of a telecommunication network, by means of the telecommunication device,
that the customer automatically receives credit for the value of the rebate on the product or the service, in the administration unit, for telecommunication services or other data technology services, free of charge to the customer, which the customer can make use of immediately and/or with a time delay, by means of telecommunication devices, by way of technical facilities made available by the central administration unit, whereupon the rebate that was granted expires.

2. Method according to claim 1, characterized in that an ID preferably the phone number of the telecommunication device, is transmitted to the central administration unit together with the information about the rebate and/or the product or the service, with which the customer can be clearly identified.

3. Method according to one of claims 1 or 2, characterized in that the amount of the rebate transmitted by means of the telecommunication device is automatically credited to the customer in a customer-specific account, using the customer-specific ID, preferably in a database, and stored there until the telecommunication service or other data technology service is utilized.

4. Method according to one of the preceding claims, characterized in that the information about the product purchased or the service utilized that was sent to the central administration unit is stored by the central administration unit together with the data of the customer.

5. Method according to claim 4, characterized in that a user profile is created from the information of every customer that is sent to the central administration unit, which reflects the consumer behavior of the customer.

6. Method according to one of claims 4 or 5, characterized in that the information about the product purchased or the service utilized and the data of the customer or the customer-specific user profile are transmitted to the vendor of the product or the performer of the service.

7. Method according to claim 6, characterized in that the data are transmitted to the vendor of the product or the performer of the service in anonymous manner.

8. Method according to claim 6, characterized in that the data are transmitted to the vendor of the product or the performer of the services linked with the user profile, if the customer agrees.

9. Method according to one of the preceding claims, characterized in that cell phones and/or land-line telephones are used as the telecommunication devices.

10. Method according to claim 9, characterized in that the information it transmitted by the customer to the central administration unit by means of SMS messages, by means of voice transmission by way of a land-line telephone, preferably a telephone that is capable of tone dialing, or by means of input by way of an Internet interface.

11. Method according to one of the preceding claims, characterized in that any type of data transmission, particularly e-mail messages, fax transmissions, SMS messages, transmission of video sequences, individual pictures, audio sequences, documents, or any form of data transmissions billed in time-dependent or volume-dependent manner can be utilized by the customer as the telecommunication service.

12. Method according to one of the preceding claims, characterized in that making available memory space on a storage unit made available by the central administration unit can be utilized by the customer as another data technology service.

13. Method according to one of the preceding claims, characterized in that information concerning the rebates of several products purchased and/or services used is transmitted to the central administration unit at the same time, in a message from the customer.

14. Method according to one of the preceding claims, characterized in that the customer opens up an account with the central administration unit, particularly by providing personal data, before the first time he/she takes advantage of a rebate.

15. Method according to claim 14, characterized in that the account can be filled up by the customer by paying in rebate amounts in the form of monetary amounts.

16. Method according to one of the preceding claims, characterized in that the customer sets his/her telecommunication device in such a manner that he/she handles his/her communications entirely by way of communication devices of the central administration unit or, optionally, when calling up the rebated telecommunication services or the other data technology services.

17. Method according to claim 16, characterized in that when using SMS messages, the short-message central number (SMSC) set at the telecommunication device refers to the central administration unit.

18. Method according to claim 1, characterized in that the customer calls up a rebated telecommunication service or another data technology service from the central administration unit anonymously, in that he/she transmits only the coded information about the amount of the discount granted to the central administration unit, in direct connection with or directly integrated into a message transmission, and that the central administration unit passes this message on to the recipient specified by the customer, immediately after having checked the coded information.

19. Method according to one of the preceding claims, characterized in that the coded information of the product or in connection with the service is automatically detected by the telecommunication device.

20. Method according to claim 19, characterized in that the coded information is read by a scanner integrated into the telecommunication device, or a similar detection unit.

21. Method according to one of claims 19 or 20, characterized in that a number code arranged on the product in covered manner is used as the coded information, which can only be exposed by the customer after purchase of the goods.

22. Method according to one of claims 19 to 21, characterized in that the bar code, particularly the EAN code, which is usually affixed to products for automatic scanning of the price, can be used as part of the coded information.

23. Method according to claim 19, characterized in that the coded information is arranged on the product in the form of a transponder and is read by a detection unit integrated into the telecommunication device.

24. Method according to one of the preceding claims, characterized in that when an attempt is made to utilize telecommunication services or other data technology services that are not covered by the customer's account balance, the data transmission is not transmitted to the addressee indicated by the customer and instead, a message to this effect is sent to the customer.
